(19) United States
(12) Patent Application Publication
(10) Pub. No.: US 2006/0161489 A1
(43) Pub. Date: Jul. 20, 2006

(54) Method and apparatus for evaluating the concentration of an asset portfolio

(76) Inventors: Machel Allen, San Diego, CA (US); Juan J. Benito, San Marcos, CA (US); Thomas Leake, London (GB); David Morris, London (GB); Barry Gillman, San Diego, CA (US)

Correspondence Address: DLA PIPER RUDNICK GRAY CARY US, LLP, 2000 UNIVERSITY AVENUE, E. PALO ALTO, CA, 94303-2248, US

(21) Appl. No.: 11/266,128

(22) Filed: Nov. 2, 2005

Related U.S. Application Data
(60) Provisional application No. 60/624,972, filed on Nov. 3, 2004.

(51) Int. Cl. G06Q 40/00

(52) U.S. Cl. 705/35

(57) ABSTRACT

Method and apparatus for determining a concentration coefficient for an asset portfolio. The concentration coefficient is determined according to the inverse of the sum of the squares of the weights of each holding in the portfolio, and expresses portfolio concentration as an equivalent number of equal-weighted holdings. In this manner, a balanced portfolio that is not weighted toward any particular holding or security is already relatively equally-weighted, and its concentration coefficient will approach the number of holdings it has. Conversely, a portfolio concentrated in few holdings will have a concentration coefficient that is lower than the number of holdings in the portfolio. Accordingly, a concentration coefficient value significantly lower than the total number of holdings generally indicates a more “concentrated” portfolio, while a concentration coefficient value approaching the total number of holdings of a portfolio indicates that the portfolio is not concentrated, and relatively “balanced.”

This application claims the benefit of U.S. Provisional Application No. 60/624,972, filed on Nov. 3, 2004, the disclosure of which is hereby incorporated by reference in its entirety and for all purposes.

### BRIEF DESCRIPTION OF THE INVENTION

This invention relates generally to securities. More specifically, this invention relates to a method and apparatus for evaluating the concentration of an asset portfolio.

### BACKGROUND OF THE INVENTION

Many strategies exist for assembling and maintaining securities portfolios, or collections of securities such as stocks, bonds, cash, and the like. For example, portfolio concentration is one approach that has received significant recent attention. This approach seeks more concentrated portfolios, on the theory that selecting the correct securities to concentrate on will yield higher returns. However, as securities that yield higher returns also tend to be more volatile, portfolio concentration is not without its risks.

Attempts to understand the mechanics of portfolio concentration remain poorly developed. Indeed, a singular definition of concentration does not exist yet. Conventional portfolio concentration methods are thus relatively crude, including such approaches as assessing the weights of a portfolio's top 10 holdings, or simply counting the total number of holdings. Accordingly, continuing efforts exist to improve the methods by which the concentration of a securities portfolio is evaluated.

### SUMMARY OF THE INVENTION

The invention can be implemented in numerous ways, including as a method, a computer readable medium, and a computing device. Various embodiments of the invention are discussed below.

As a method of evaluating an asset portfolio having a plurality of holdings, one embodiment of the invention comprises providing a market value weight of each holding relative to a total market value of the asset portfolio. A concentration metric is determined from the weights, the concentration metric representing a number of equivalent holdings having equal associated weights.

As a computer readable medium having computer executable instructions thereon for a method of evaluating an asset portfolio having a plurality of holdings, the method of another embodiment of the invention comprises providing a market value weight of each holding relative to a total market value of the asset portfolio. A concentration metric is determined from the weights, the concentration metric representing a number of equivalent holdings having equal associated weights.

As a device for evaluating an asset portfolio having a plurality of holdings, another embodiment of the invention comprises an input configured to receive a market value weight of each holding relative to a total market value of the asset portfolio. Also included is a processor configured to calculate a concentration metric from the weights, the concentration metric representing a number of equivalent holdings having equal associated weights.

Other aspects and advantages of the invention will become apparent from the following detailed description taken in conjunction with the accompanying drawings which illustrate, by way of example, the principles of the invention.

### BRIEF DESCRIPTION OF THE DRAWINGS

For a better understanding of the invention, reference should be made to the following detailed description taken in conjunction with the accompanying drawings, in which:

FIG. 1 illustrates exemplary concentration coefficients calculated according to the present invention.

FIG. 2 is an exemplary spreadsheet illustrating concentration coefficient calculations in accordance with the present invention.

FIG. 3 further illustrates the spreadsheet calculations of FIG. 2.

FIG. 4 is a graph of the number of stocks of various portfolios, versus their corresponding concentration coefficients.

FIG. 5 is a graph of the concentration coefficients of various portfolios in a peer group, plotted over time.

FIG. 6 is a graph of the concentration coefficients of various benchmarks, plotted over time.

FIG. 7 is a graph of the concentration coefficients of two benchmarks plotted over time, illustrating the behavior of the concentration coefficients.

FIG. 8 is a graph of the concentration coefficients of various portfolios in a peer group, relative to the concentration coefficients of a benchmark, plotted over time.

FIG. 9 illustrates distributions of concentration coefficients within various peer groups.

Like reference numerals refer to corresponding parts throughout the drawings.

### DETAILED DESCRIPTION OF EMBODIMENTS OF THE INVENTION

The invention relates to a method and apparatus for determining a concentration coefficient for an asset portfolio. The concentration coefficient is determined according to the inverse of the sum of the squares of the weights of each holding in the portfolio. Accordingly, it expresses portfolio concentration as an equivalent number of equal-weighted holdings. That is, portfolios typically are not equally weighted: each holding varies in market value, with some holdings being more valuable than others. For such a portfolio, the concentration coefficient determines an “equivalent” number of equally-weighted holdings that represents the “concentration” of that portfolio. In this manner, a balanced portfolio that is not weighted toward any particular holding or security is already relatively equally-weighted, and its concentration coefficient will approach the number of holdings it has. Conversely, a portfolio concentrated in few holdings will have a concentration coefficient that is lower than the number of holdings in the portfolio. Accordingly, a concentration coefficient value significantly lower than the total number of holdings generally indicates a more “concentrated” portfolio, while a concentration coefficient value approaching the total number of holdings of a portfolio indicates that the portfolio is not concentrated, and relatively “diversified.”

As used herein, “holding” or “stock” represents all shares or other financial interest in a single publicly traded entity (e.g., company), asset type (e.g., stocks, bonds, etc.), industry, or country. For example, if 10 shares of company A are purchased in year 1, and 15 shares are purchased in year 2, then the “stock” or “holding” from company A would include all 25 shares of company A.

In accordance with one embodiment of the invention, such a concentration coefficient, which is simply a metric employed to measure the concentration of a portfolio, can be expressed for a particular portfolio as:

$$CC = \frac{1}{{\sum }_{i = 1}^{N} {w}_{i}^{2}} \qquad ( 1 )$$

where
N is the number of holdings within the portfolio
wᵢ is the market value weight of the i^{th} holding of the portfolio

The calculation of weights w is typically expressed as the percentage of the portfolio's entire value taken up by that particular holding.

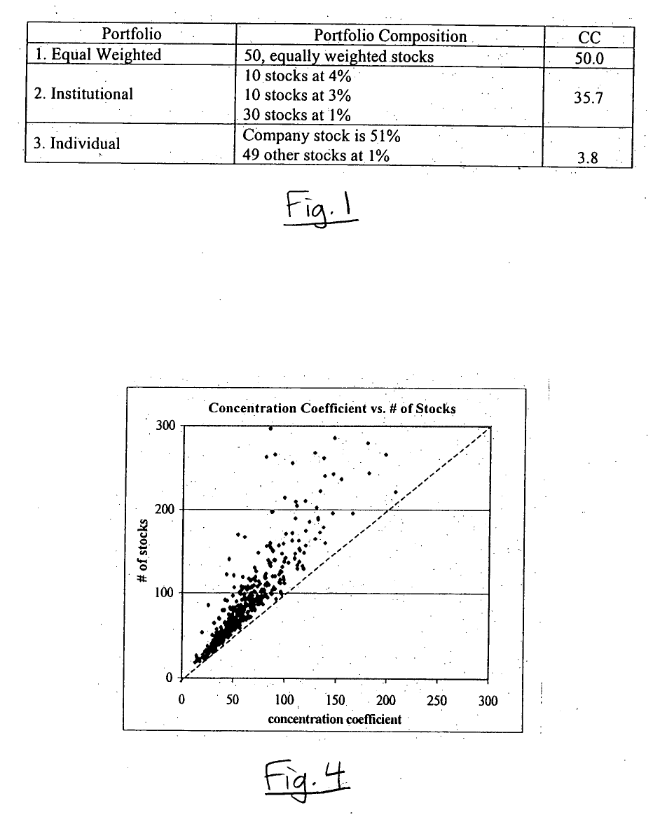

As an illustration of concepts expressed in equation (1), FIG. 1 illustrates 3 exemplary portfolios, along with exemplary concentration coefficients calculated according to an embodiment of the present invention. In the first example, a portfolio containing 50 equally weighted stocks has weights wᵢ each equal to 2%, or 0.02 (i.e., each holding has a market value representing 2% of the entire market value of the portfolio). This yields a concentration coefficient CC equal to 50. That is, in an exactly equally weighted portfolio, each holding is already equally-weighted. Accordingly, the CC is equal to the number of holdings (i.e., 50 different stocks, in this case).

The portfolio of the second example is representative of many institutional portfolios. It is somewhat “diversified” or “well balanced,” with no particular stock taking up more than 4% of the portfolio's overall market value, and 50 different stocks or holdings. Its concentration coefficient, as calculated according to equation (1), is 35.7. That is, for purposes of determining how concentrated this portfolio is, it can be thought of as having 35.7 equally-weighted holdings. The difference between this number and 50, which is the actual number of holdings, is a measure of how concentrated the portfolio is. Thus, it can be seen that even though the portfolio is relatively diversified by many conventional metrics, it falls short of being ideally diversified, as indicated by the concentration coefficient metric (in which case it would have a CC equal to 50).

The portfolio of the third example is dominated by one stock. Namely, the stock of a single company makes up 51% of the portfolio's market value, while 49 other stocks each take up 1%. According to equation (1), this portfolio would have a concentration coefficient of 3.8, far short of the maximum or perhaps ideal value of 50. In this example, the concentration coefficient illustrates that the portfolio can be thought of as being made up of only 3.8 equally-weighted stocks, implying that it is relatively highly concentrated.

One of ordinary skill in the art will observe that the invention is not limited to the particular embodiment expressed in equation (1). Rather, the invention encompasses the determination of any metric that determines an equivalent number of equally-weighted (or near-equally-weighted) portfolios. Also, it will be observed that the invention can be applied to the determination of concentration levels of holdings besides securities. For instance, equation (1) and other such equations in accordance with the invention can be applied to determine the concentration level of the cash position in a portfolio, by determining the weight of the cash position in relation to the remainder of the portfolio's assets. Also, by considering a “holding” in a more general sense of any asset category, equation (1) and others can be employed to determine the concentration level of holdings from a particular country, or a particular industry, simply by determining the weight of each of these asset categories relative to the total assets of the portfolio.

It will also be observed that the methods of the invention can be implemented in any fashion, whether by manual calculation or by calculations performed by instructions stored on a computer or other automated device. Indeed, solutions of equation (1) and other embodiments of the invention are preferably calculated using any of a variety of computing devices, including personal computers, programmable calculators, PDAs, and any other devices having an input for receiving the raw financial data, and a processor for executing calculations such as those required by equation (1). Most computer programming languages can be used to implement the required mathematical computations. Thus, virtually any computer program language can be used to develop software and/or firmware that calculates concentration coefficients or other metrics from investment portfolio information.

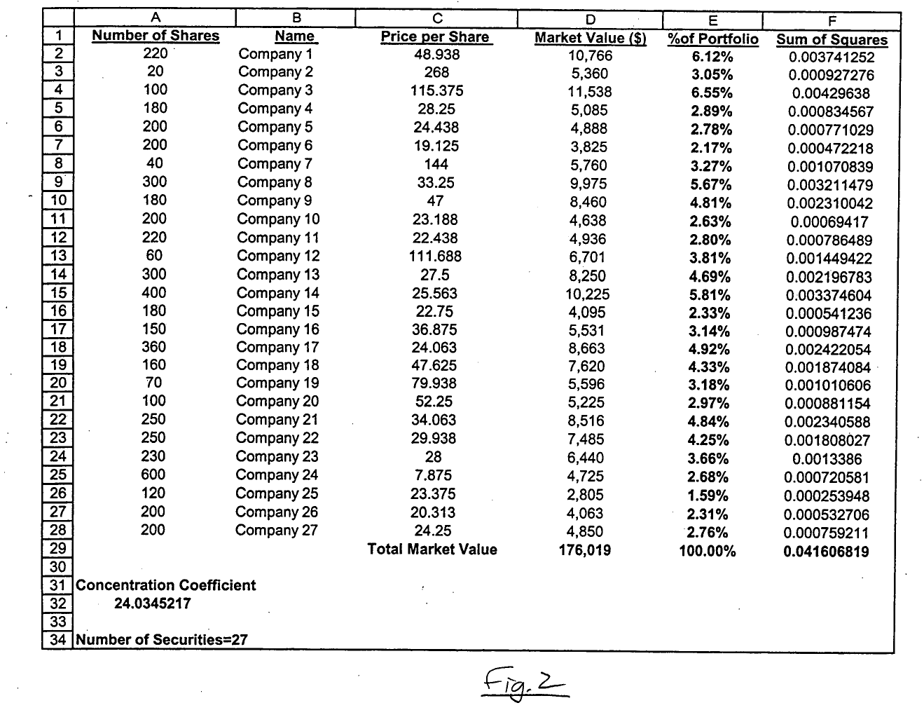

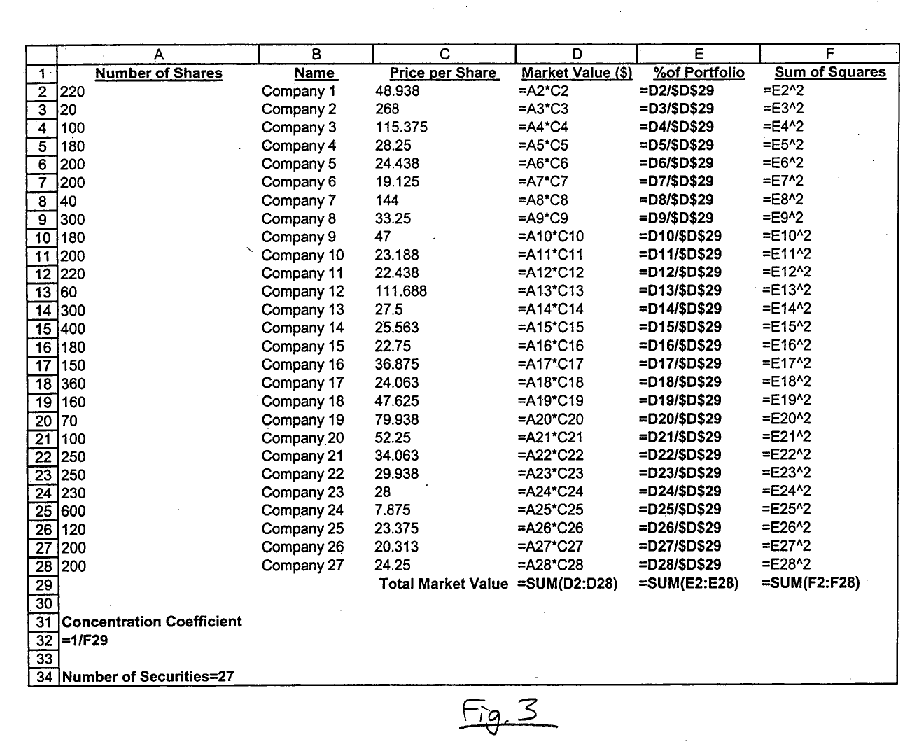

In fact, even software programs not dedicated to financial calculations can be so used. For example, FIG. 2 is an exemplary spreadsheet illustrating results that can be generated using many conventional spreadsheet programs. The spreadsheet illustrates, for each exemplary company, 1) the Market Value of the company's shares, as calculated by multiplying the Number of Shares by their corresponding Price per Share, 2) the % of Portfolio, as calculated by dividing Market Value by Total Market Value of the portfolio, representing the weight wᵢ, and 3) the Sum of Squares, calculated as the square of the % of Portfolio. The Concentration Coefficient for the entire portfolio is calculated by summing each of the Sum of Square values, and taking the inverse of that sum. FIG. 3 illustrates the calculations required to achieve the results of FIG. 2.

Having demonstrated the calculation of concentration coefficients according to equation (1), attention now turns to various applications. It will be seen that the concentration coefficients of the invention offer numerous advantages when applied to financial analysis.

For example, concentration coefficients in accordance with the invention provide a convenient mechanism for determining how concentrated a portfolio is, and accordingly whether the portfolio should be more or less diversified. FIG. 4 is a graph of the number of stocks of various exemplary portfolios, plotted versus their corresponding concentration coefficients. The dotted line in FIG. 4 corresponds to concentration coefficients that have values equal to the number of holdings in their portfolios, i.e., exactly equally weighted portfolios. Accordingly, portfolios can approach this line but not cross it, and the degree of deviation from this line indicates how concentrated the portfolios are. As shown in FIG. 4, portfolios having concentration coefficients close to the dotted line are not highly concentrated in any particular holdings. Such portfolios are, relatively speaking, very diversified and, if this attribute is desired, need not be altered simply on the basis of concentration. Conversely, portfolios having concentration coefficients away from the dotted line, such as those represented by the points in the upper left portion of FIG. 4, are relatively concentrated. This may be a desired attribute in certain portfolios such as those constructed according to portfolio concentration techniques, in which case the portfolios need not be altered simply on the basis of concentration. However, if excessive concentration is not desired, such concentration coefficient values highlight the need to alter the makeup of those portfolios so as to reduce their concentration level. In this manner, it can be observed that concentration coefficients of the invention provide a relatively quick and clear method of determining the makeup of securities portfolios.

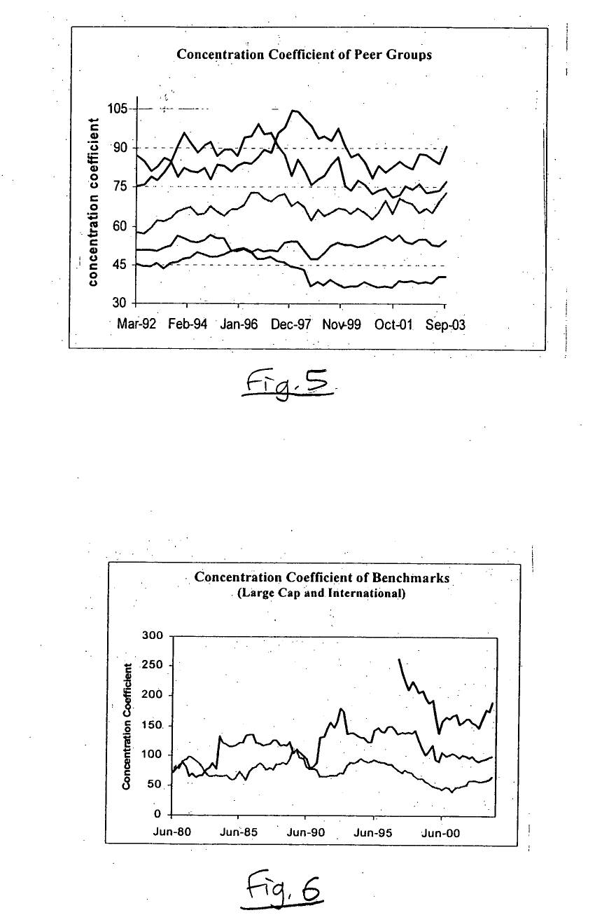

As another example, methods of the invention can be employed to determine the degree of concentration of various portfolios in a peer group, or any set of portfolios whose collective concentrations are to be monitored/compared. In this manner, methods of the invention provide metrics by which peer portfolios can be compared and individually monitored so as to maintain comparable concentration levels. FIG. 5 is a graph of the concentration coefficients of various portfolios in a peer group, plotted over time. As can be observed, the determination and plotting of concentration levels of different portfolios allows for identification of which portfolios in a peer group are more or less concentrated than desired. Once identified, the makeup of these portfolios can be modified as appropriate.

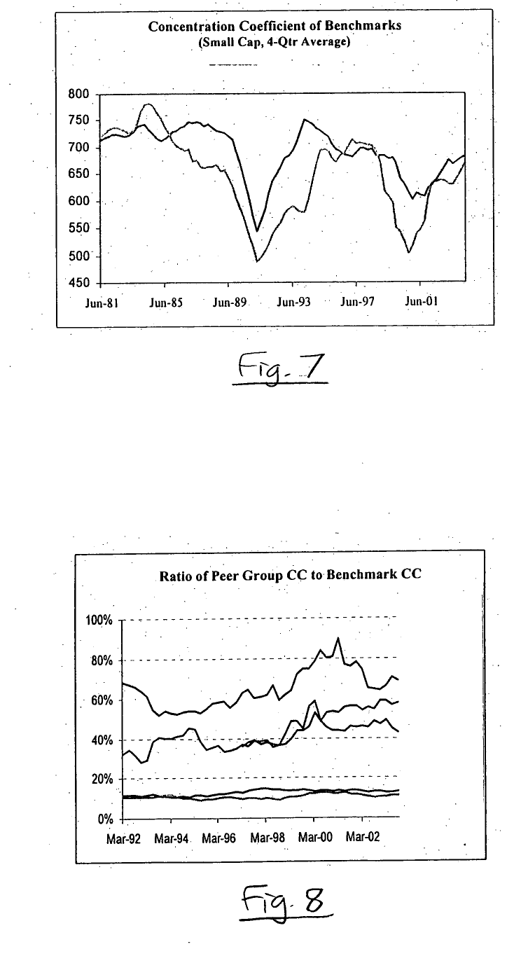

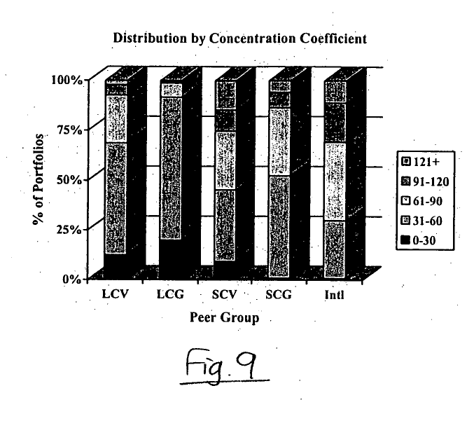

As a further example, the determination of concentration coefficients can be applied to portfolios such as indices. In this manner, the concentration level of securities portfolios can be compared to the concentration level of various benchmarks. FIGS. 6-7 are graphs of the concentration coefficients of various benchmarks plotted over time, with FIG. 6 being a graph of various large-cap and international indices, and FIG. 7 being a graph of small-cap indices. In accordance with the invention, the concentration coefficient of securities portfolios of interest can be compared to the concentration coefficients of indices, so as to determine whether a particular portfolio is becoming more or less concentrated than a particular benchmark. FIG. 8 is a graph of the concentration coefficients of various portfolios of a peer group, expressed as a percentage of the concentration coefficient of a benchmark index. It can be observed that two of the portfolios have concentration coefficients that are consistently low as compared to the concentration coefficient of the benchmark index (approximately 15% of the benchmark's concentration coefficient), meaning that these two portfolios are consistently significantly more concentrated than the benchmark index. In contrast, the other three portfolios have concentration coefficients that are a variable but somewhat higher percentage of that of the benchmark index, meaning that these three portfolios are more concentrated than the benchmark, although to a more variable degree and less so than the first two portfolios. Accordingly, concentration coefficients in accordance with the invention can be applied to keep track of both the absolute concentration level of a portfolio, as well as its concentration level relative to that of a particular benchmark.

As a final example, the determination of concentration coefficients can be applied to measure the distribution of concentration levels within a particular group of portfolios. FIG. 9 illustrates distributions of concentration coefficients within various peer groups. This allows for a relatively quick determination of the concentration makeup of various groups of portfolios. For example, one can observe which peer groups contain a large percentage of portfolios at a particular concentration level, such as the second from the left in FIG. 9.

The foregoing description, for purposes of explanation, used specific nomenclature to provide a thorough understanding of the invention. However, it will be apparent to one skilled in the art that the specific details are not required in order to practice the invention. Thus, the foregoing descriptions of specific embodiments of the present invention are presented for purposes of illustration and description. They are not intended to be exhaustive or to limit the invention to the precise forms disclosed. Many modifications and variations are possible in view of the above teachings. For example, the methods of the invention can be employed to determine a concentration coefficient or other such metric that indicates the concentration of any asset within a portfolio. The embodiments were chosen and described in order to best explain the principles of the invention and its practical applications, to thereby enable others skilled in the art to best utilize the invention and various embodiments with various modifications as are suited to the particular use contemplated.

What is claimed is:

1. A method of evaluating an asset portfolio having a plurality of holdings, comprising:
providing a market value weight of each holding relative to a total market value of the asset portfolio; and
determining a concentration metric from the weights, the concentration metric representing a number of equivalent holdings having equal associated weights.

2. The method of claim 1 wherein the determining further comprises determining the concentration metric according to:
$$\frac{1}{{\sum }_{i = 1}^{N} {( {w}_{i} )}^{2}}$$
wherein n is a total number of the plurality of holdings, and w is the market value weight of the ith one of the plurality of holdings.

3. The method of claim 2 further comprising calculating a difference between the determined concentration metric and the total number of the holdings in the asset portfolio.

4. The method of claim 2 further comprising revising the concentration metric from time to time so as to track the concentration metric of the asset portfolio over a period of time.

5. The method of claim 2 further comprising, for a plurality of the asset portfolios, repeating the determining so as to determine the concentration metric corresponding to each of the asset portfolios.

6. The method of claim 5:
wherein a first one of the asset portfolios is a benchmark index; and
wherein the repeating further comprises repeating the determining so as to determine the concentration metric of the benchmark index and the concentration metric of a second asset portfolio, and comparing the concentration metric of the benchmark index to the concentration metric of a second asset portfolio so as to determine a degree of concentration of the second asset portfolio relative to the benchmark index.

7. The method of claim 5:
wherein a first one of the asset portfolios is a benchmark index; and
wherein the repeating further comprises repeating the determining so as to determine the concentration metric of the benchmark index and the concentration metrics of a peer group of asset portfolios, and comparing the concentration metric of the benchmark index to the concentration metrics of a peer group of asset portfolios so as to determine degrees of concentration of the peer group of asset portfolios relative to the benchmark index.

8. The method of claim 5 wherein the repeating further comprises repeating the determining so as to determine the concentration metrics of a peer group of asset portfolios, and comparing the concentration metrics of the peer group of asset portfolios to each other so as to facilitate a redistribution of the assets within the peer group of asset portfolios.

9. The method of claim 2 wherein one of the holdings is a cash position, and wherein the corresponding concentration metric is a measure of the concentration of the cash position within the asset portfolio.

10. The method of claim 2 wherein each of the holdings is a set of assets from organizations within a particular industry.

11. The method of claim 2 wherein each of the holdings is a set of assets from organizations of a particular country.

12. A computer readable medium having computer executable instructions thereon for a method of evaluating an asset portfolio having a plurality of holdings, the method comprising:
providing a market value weight of each holding relative to a total market value of the asset portfolio; and
determining a concentration metric from the weights, the concentration metric representing a number of equivalent holdings having equal associated weights.

13. The computer readable medium of claim 12 wherein the determining of the method further comprises determining the concentration metric according to:
$$\frac{1}{{\sum }_{i = 1}^{N} {( {w}_{i} )}^{2}}$$
wherein n is a total number of the plurality of holdings, and w is the market value weight of the ith one of the plurality of holdings.

14. The computer readable medium of claim 13 wherein the method further comprises calculating a difference between the determined concentration metric and the total number of the holdings in the asset portfolio.

15. The computer readable medium of claim 13 wherein the method further comprises revising the concentration metric from time to time so as to track the concentration metric of the asset portfolio over a period of time.

16. The computer readable medium of claim 13 wherein the method further comprises, for a plurality of the asset portfolios, repeating the determining so as to determine the concentration metric corresponding to each of the asset portfolios.

17. A device for evaluating an asset portfolio having a plurality of holdings, comprising:
an input configured to receive a market value weight of each holding relative to a total market value of the asset portfolio; and
a processor configured to calculate a concentration metric from the weights, the concentration metric representing a number of equivalent holdings having equal associated weights.

18. The device of claim 17 wherein the processor is further configured to calculate the concentration metric according to:
$$\frac{1}{{\sum }_{i = 1}^{N} {( {w}_{i} )}^{2}}$$
wherein n is a total number of the plurality of holdings, and w is the market value weight of the ith one of the plurality of holdings.

19. The device of claim 18 wherein the processor is further configured to calculate a difference between the determined concentration metric and the total number of the holdings in the asset portfolio.

20. The device of claim 18 wherein the processor is further configured to revise the concentration metric from time to time so as to track the concentration metric of the asset portfolio over a period of time.

21. The device of claim 18 wherein the processor is further configured to calculate a corresponding one of the concentration metric for each of a plurality of the asset portfolios.
